(19) United States
(12) Patent Application Publication
(10) Pub. No.: US 2024/0359282 A1
(43) Pub. Date: Oct. 31, 2024

(54) PHOTOLUMINESCENT TOOLING, TOOLING INSPECTION METHOD, AND TOOLING INSPECTION APPARATUS

(71) Applicant: Stolle Machinery Company, LLC, Centennial, CO (US)

(72) Inventors: JOSEPH JOHN ALLEN MAURER, Aurora, CO (US); Ian Kenneth Scholey, Barnsley (GB)

(73) Assignee: Stolle Machinery Company, LLC, Centennial, CO (US)

(21) Appl. No.: 18/139,662

(22) Filed: Apr. 26, 2023

(51) Int. Cl. B23Q 17/24; B21D 37/10; B21D 51/26

(52) U.S. Cl. CPC B23Q 17/2457; B21D 37/10; B21D 51/2638

(57) ABSTRACT

An arrangement for use in forming a can body, the arrangement including a forming die structured to form a portion of the can body, the forming die having a portion comprising a photoluminescent material.

### FIELD OF THE INVENTION

The disclosed concept relates generally to arrangements for use in forming a can body and to apparatus employing such arrangements. More particularly, the disclosed concept relates to arrangements for use in forming a can body, or selected portions thereof, that utilize photoluminescent material(s) therein to provide for detection of flaws and/or contaminants. The disclosed concept further relates methods for carrying out detection of flaws using such arrangements.

### BACKGROUND OF THE INVENTION

Over time, can and end tooling for forming can bodies and/or one or more portions thereof (e.g., without limitation, cuppers, bodymakers, neckers, flangers, reformers, shell presses, conversion presses, etc.) can become scratched or otherwise damaged and/or can pickup material particles (e.g., without limitation, aluminum) during the manufacturing process. Such occurrence(s) create(s) an unstable forming process which then leads to failure to create a successful form due to a variation in coefficient of friction, non-symmetrical draw or iron conditions, and/or abrasive surfaces. When this occurs, spoilage rates may increase abruptly or more often gradually, which makes it very hard to monitor such condition(s). Presently, when a problem is detected or suspected a machine must be stopped to inspect the tooling which thus stops production. In many cases, it is not known if there is material accumulation on the tooling or if the tooling is actually scratched or otherwise damaged. If it is not known and the accumulation cannot be easily cleaned off, the tooling will be reworked or discarded which can be very costly.

### SUMMARY OF THE INVENTION

Embodiments of the disclosed concept address deficiencies in the prior art in one aspect by providing an arrangement for use in forming a can body. The arrangement comprises: a forming die structured to form a portion of the can body, the forming die having a portion comprising a photoluminescent material.

The arrangement may further comprise: a source of UV light positioned and structured to illuminate the portion of the forming die; and an image capturing device positioned and structured to capture a number of images of the portion of the forming die illuminated by the source of UV light. The arrangement may further comprise a processor in communication with the image capturing device. The source of UV light and the image capturing device may comprise portions of an inspection camera.

The forming die may comprise a necking die for use in performing a necking operation on a can body.

The photoluminescent material may be impregnated in the forming die.

The photoluminescent material may be provided in the forming die via a doping process.

As another aspect of the disclosed concept, an apparatus for forming a portion of a can body is provided. The apparatus comprises: a forming die having a portion comprising a photoluminescent material; a number of arrangements structured to move the can body into and/or out of contact with the forming die; a source of UV light positioned and structured to illuminate the portion of the forming die; and an image capturing device positioned and structured to capture a number of images of the portion of the forming die illuminated by the source of UV light.

The apparatus may further comprise a processor in communication with the image capturing device.

The source of UV light and the image capturing device may comprise portions of an inspection camera.

The photoluminescent material may be impregnated in the forming die.

The photoluminescent material may be provided in the forming die via a doping process.

The number of arrangements may comprise a number of transfer assemblies.

The forming die may comprise a necking die for use in performing a necking operation on a can body.

The apparatus may comprise a processing station of a necker machine.

As yet a further aspect of the disclosed concept, a method of monitoring wear of a forming die structured to form a portion of a can body is provided. The method comprises: receiving a plurality of images of a portion of the forming die; determining a difference in at least two images of the plurality of images corresponding to a change in the forming die; and responsive to said determining, outputting an indication of the change.

Receiving the plurality of images of the portion of the forming die may comprise obtaining the plurality of images with an image capturing device positioned adjacent the portion of the forming die. The method may further comprise illuminating the portion of the forming die with a light source while obtaining the plurality of images. The forming die may comprise a photoluminescent material, and illuminating the portion of the forming die with the light source may comprise illuminating the portion of the forming die with a source of ultraviolet light.

These and other objects, features, and characteristics of the disclosed concept, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are provided for the purpose of illustration and description only and are not intended as a definition of the limits of the concept.

### BRIEF DESCRIPTION OF THE DRAWINGS

A full understanding of the invention can be gained from the following description of the preferred embodiments when read in conjunction with the accompanying drawings in which:

FIG. 1 is a partially schematic representation of an arrangement for use in forming a can body in accordance with one example embodiment of the disclosed concept;

FIG. 2 is a perspective view of a processing station of a necker machine in accordance with one example embodiment of the disclosed concept;

FIG. 3 is a side elevation view of the processing station of FIG. 2 including an arrangement such as shown in FIG. 1 in accordance with one example embodiment of the disclosed concept;

FIG. 4 is a top view of the processing station of FIGS. 2 and 3;

FIG. 5 is a sectional view of the processing station of FIGS. 2-4 taken along line 5-5 of FIG. 3;

FIG. 6 is another sectional view of the processing station of FIGS. 2-4 taken along line 6-6 of FIG. 3; and

FIG. 7 is a flow chart showing general steps of a method in accordance with an example embodiment of the disclosed concept.

### DETAILED DESCRIPTION OF THE INVENTION

It is to be appreciated that the specific elements illustrated in the drawings and described herein are simply exemplary embodiments of the disclosed concept. Accordingly, specific dimensions, orientations and other physical characteristics related to the embodiments disclosed herein are not to be considered limiting on the scope of the disclosed concept.

As employed herein, the term “can” refers to any known or suitable container, which is structured to contain a substance (e.g., without limitation, liquid, food, any other suitable substance), and expressly includes, but is not limited to, beverage cans, such as beer and soda cans, as well as cans used for food.

As used herein, “coupled” means a link between two or more elements, whether direct or indirect, so long as a link occurs. An object resting on another object held in place only by gravity is not “coupled” to the lower object unless the upper object is otherwise maintained substantially in place. That is, for example, a book on a table is not coupled thereto, but a book glued to a table is coupled thereto.

As used herein, “directly coupled” means that two elements are coupled in direct contact with each other.

As used herein, “fixedly coupled” or “fixed” means that two components are coupled so as to move as one while maintaining a constant orientation relative to each other. The fixed components may, or may not, be directly coupled.

As used herein, the word “unitary” means a component is created as a single piece or unit. That is, a component that includes pieces that are created separately and then coupled together as a unit is not a “unitary” component or body.

As used herein, “associated” means that the identified components are related to each other, contact each other, and/or interact with each other. For example, an automobile has four tires and four hubs, each hub is “associated” with a specific tire.

As used herein, “engage,” when used in reference to gears or other components having teeth, means that the teeth of the gears interface with each other and the rotation of one gear causes the other gear to rotate as well.

As employed herein, the term “number” shall mean one or an integer greater than one (i.e., a plurality).

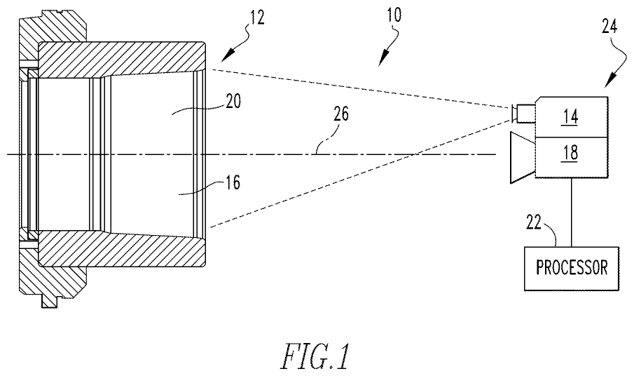

Referring now to FIG. 1, a partially schematic representation of an arrangement 10 for use in forming a can body (or portion thereof) in accordance with one example embodiment of the disclosed concept is provided. The arrangement 10 includes a forming die 12 that is structured to form a portion of the can body, an ultraviolet (UV) light source 14 positioned to illuminate at least a portion 16 of the forming die 12, and an image capturing device 18 positioned and structured to capture a number of images of the portion 16 of the forming die 12 illuminated by the UV light source 14. In the example embodiment illustrated herein, the forming die 12 is a necking die (shown in cross-section in FIG. 1) such as used in a conventional necking machine along with other necking dies to form (i.e., neck) the top portion of a can body, a process generally known by one of ordinary skill in the art. It is to be appreciated that, although described in conjunction herein with a necking die, embodiments/applications of the disclosed concept are not limited to necking dies and/or necking machines, but instead are generally applicable to other forming arrangements (e.g., without limitation, cuppers, bodymakers, neckers, flangers, reformers, shell presses, conversion presses, etc.) without varying form the scope of the disclosed concept. It is also to be appreciated that with improved imaging/processing and lighting embodiments of the disclosed concept could be carried out using non-luminescent materials and lighting other than UV without varying from the scope of the disclosed concept.

Continuing to refer to FIG. 1, the forming die 12 includes a forming surface 20 (which in the example shown in FIG. 1 generally coincides with the illuminated portion 16) which comprises a photoluminescent material provided as part of the forming die 12. Embodiments of the disclosed concept generally utilize photoluminescent compounds and/or elements such as a phosphor material or materials impregnated into the forming die 12, however any other suitable material(s) may be used without varying form the scope of the disclosed concept. The photoluminescent material(s) may be provided in/with the die 12 via any suitable process without varying from the scope of the disclosed concept. In some example embodiments in accordance with the disclosed concept, the die 12 is formed from a powdered ceramic or other material. The powder material(s) is(are) mixed with a binder and a phosphor like material to become a homogenous or uniform mixture. The composition of the binder is typically between 5 and 15% and the phosphor additive can be as little as 0.5% and as high as 20%. Once the mixture has been made, a body is made by forming, pressing, or 3D printing. This body is referred to as a green body and is usually low in density. A sintering process via hipping is then performed which utilizes high heat (e.g., 800-2000° C.) and pressure to cause diffusion to occur which does not melt a binder or use ingredients within the green body but rather binds them together atomically. The binder then adheres the ceramic or other use material together. The body is then annealed to remove grain vacancies and create a uniform crystalline structure throughout the entire body. During this process, which is usually performed by means of isostatic pressing, the green body is reduced to approximately 30% of it's original size and final shape set once the heat from the sintering process is returned back to normal temperatures. Final hardness of the green body is then 70-105 Rc in hardness. Once the green body has been annealed, the shape is now referred to as a “blank”. The blank is then precision ground via a grinder to the final tooling dimensions which will be used to form a can body or portion thereof.

In some other example embodiments in accordance with the disclosed concept, in lieu of adding the photoluminescent material(s) prior to the hipping process, a post treatment via a doping technique is instead used after the final grind of the material. Doping may be used by creating an electrostatic bond between the blank or die and the photoluminescent material which in such case is provided in a gas form. A hipping or heating process is applied which atomically bonds the photoluminescent material(s) to the surface of the die. This process needs to be performed routinely in embodiments where the tooling is polished normally with an abrasive medium. However, techniques that use solvent baths which only react with targeted contaminants such as aluminum may be employed thus reducing the need to repeat the aforementioned process.

When illuminated by the UV light source 14, the photoluminescent material(s) present in the forming die 12 serve to readily identify any imperfections (e.g., scratches, gouges, material deposits, etc.) on the forming surface(s) 20 of the forming die 12 as such imperfections will stand out relative to the surrounding surface and thus be readily detectable by the image capturing device 18. In order to provide for analysis of a plurality of images captured by the image capturing device 18 over a short length of time (e.g., such as after each can body of a plurality of can bodies has been formed by the forming die 12 such as discussed further below), the arrangement 10 may include a processor 22 in communication with the image capturing device 18. The processor 22 may be, for example and without limitation, a microprocessor, a microcontroller, or some other suitable processing device or circuitry, that interfaces with a suitable memory (not numbered). The memory can be any of one or more of a variety of types of internal and/or external storage media such as, without limitation, RAM, ROM, EPROM(s), EEPROM(s), FLASH, and the like that provide a storage register, i.e., a machine readable medium, for data storage such as in the fashion of an internal storage area of a computer, and can be volatile memory or nonvolatile memory. The memory has stored therein a set of instructions that are generally in the form of routines or other types of instructions which, when executed on/by the processor 22, cause the processor 22 to perform certain predetermined functions. For example, the processor 22 may be programmed to analyze the images captured by the image capturing device 18 to determine the absence or presence of imperfections on the forming surface(s) 20 of the forming die and carry out further actions responsive to such determination. For example, if no imperfections are determined to be present the processor 22 may provide an indication that all is good or simply do nothing. If one or more imperfections are determined, the processor 22 may be programmed to determine if such imperfections exceed a predetermined threshold and if so trigger an alarm for an operator, cease operations of the forming process, and/or any other suitable outcome depending on the particular application. As another example, the processor 22 may be programmed to analyze the images captured by the image capturing device 18 for a change or changes within the images and if the rate of such change(s) exceeds a predetermined rate an alarm or other suitable action may be carried out to notify an operator that subsequent action(s) is(are) required.

As generally shown schematically in the example embodiment illustrated in FIG. 1, the image capturing device 18 and the UV light source 14 may be combined in the form of a single device 24, such as an inspection camera or other suitable arrangement. In the example arrangement of FIG. 1, the image capturing device 18 is aligned generally concentrically with the forming die 12 (i.e., aligned with a central axis 26 of the forming die 12), however it is to be appreciated that other positioning(s) of the image capturing device 18 may be employed without varying from the scope of the disclosed concept.

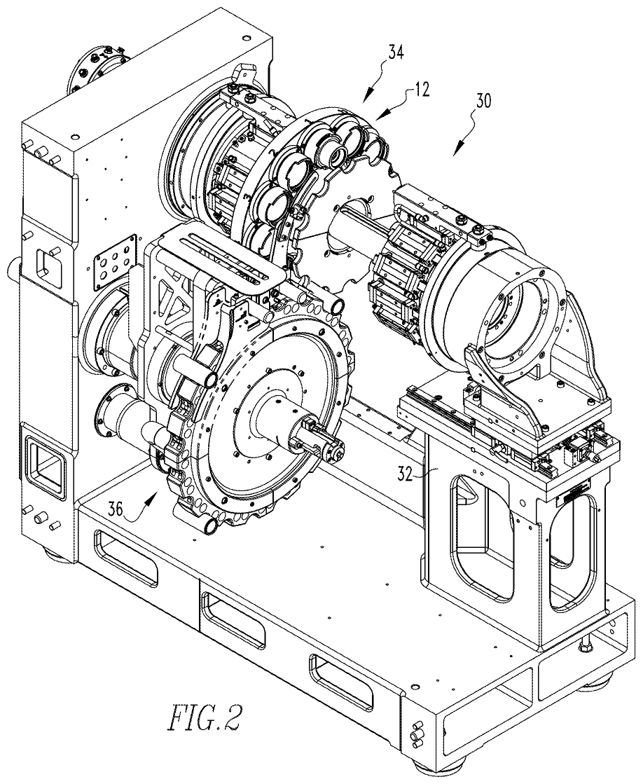

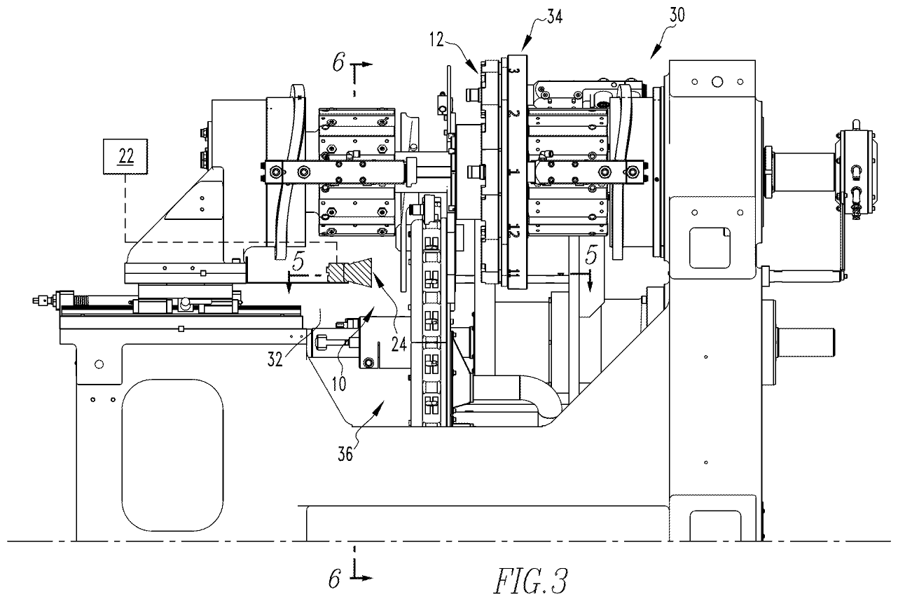

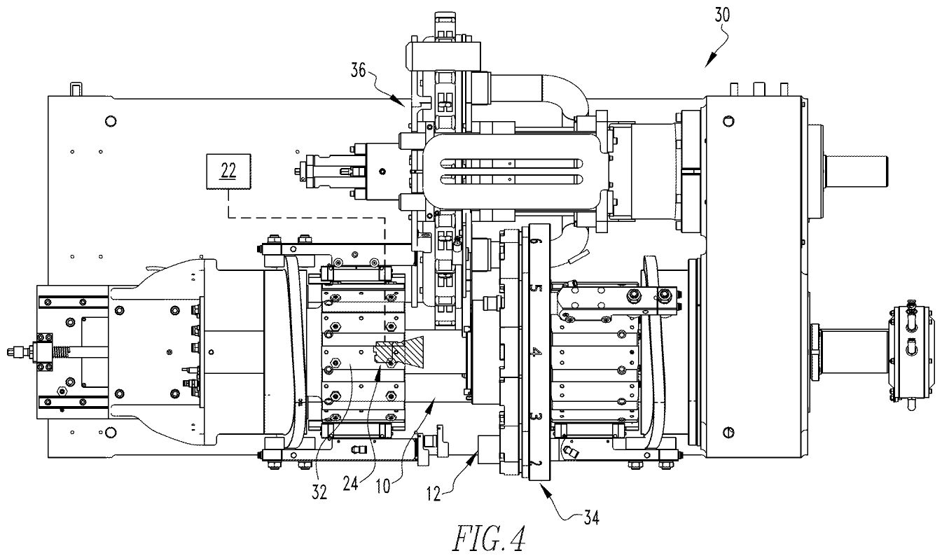

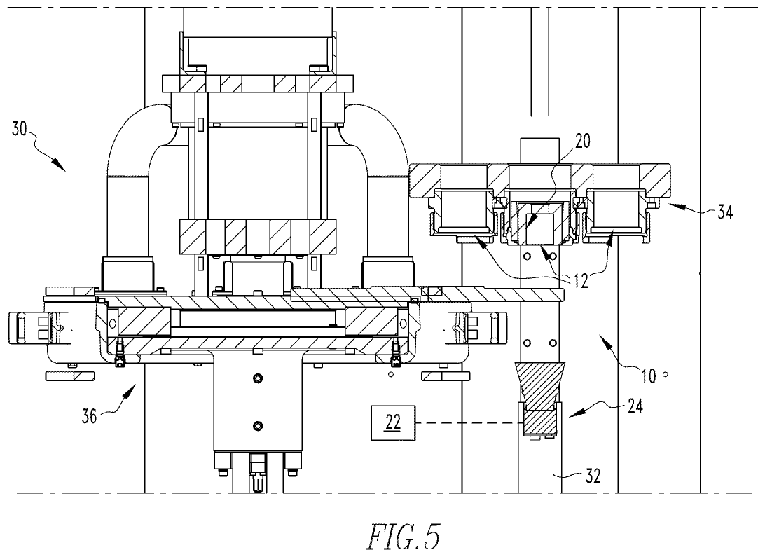

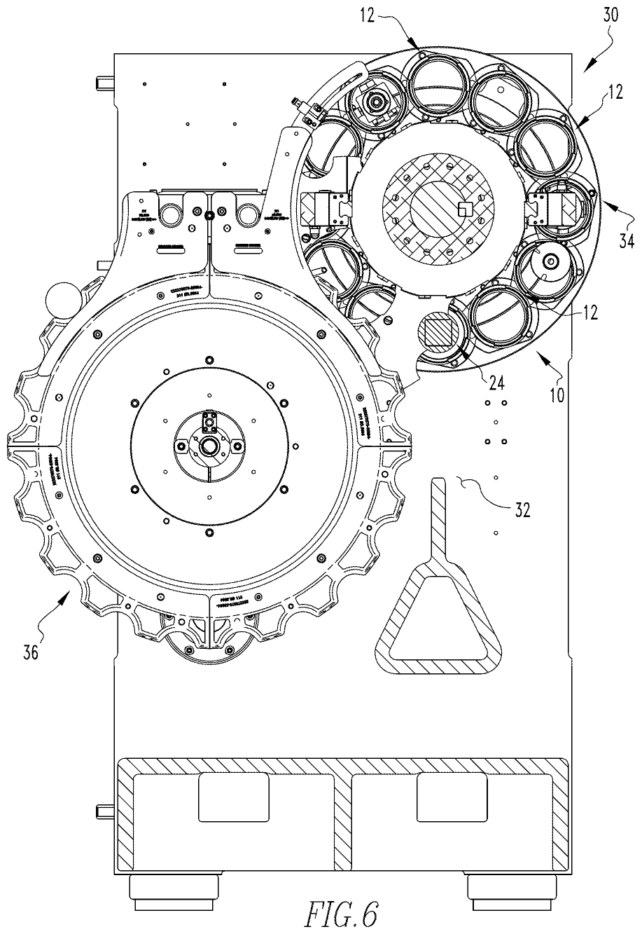

FIGS. 2-6, show an example of an apparatus for forming a portion of a can body in accordance with an example embodiment of the disclosed concept. More particularly, FIGS. 2-6 show an example embodiment in accordance with the disclosed concept wherein the arrangement 10 is shown employed in a processing station 30 of a necker machine (such as described in U.S. Pat. No. 11,370,015, the contents of which are incorporated herein by reference). In such application, the inspection camera 24 is fixedly coupled to a frame 32 of the processing station 30 facing the forming dies 12 of a processing turret 34. More particularly, the inspection camera 24 is positioned so as to be concentrically aligned periodically with respective exposed (i.e., empty) forming dies 12 of the processing turret 34 in the timing between when each of such dies 12 have had a necked can body removed therefrom (e.g., by a transfer assembly of an adjacent processing station) and when each of such dies receives a can body to be necked from a transfer assembly 36 of the processing station 30.

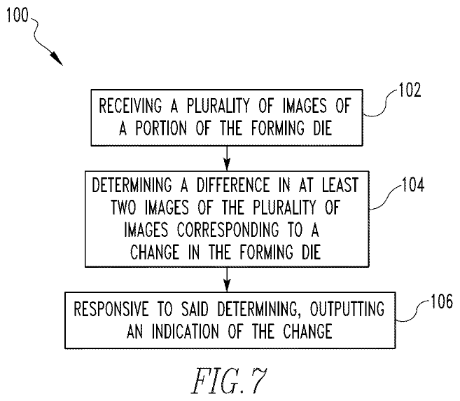

Having thus described some example arrangements in accordance with embodiments of the disclosed concept, a general method 100 in accordance with an example embodiment of the disclosed concept will now be briefly discussed on conjunction with FIG. 7. The method 100 begins at 102 wherein a plurality of images of a portion of a forming die are received. In an arrangement such illustrated in FIG. 1, such images would be received by the processor 22 subsequent to being captured by the image capturing device 18 positioned adjacent the portion 16 of the forming die 12. The method may include illuminating the portion of the forming die with a light source while obtaining the plurality of images. In embodiments wherein the forming die comprises a photoluminescent material, illuminating the portion of the forming die with the light source may comprise illuminating the portion of the forming die with a source of ultraviolet light. Next, at 104, the plurality of images are analyzed so as to determine a difference in at least two images of the plurality of images corresponding to a change in the forming die. Responsive to such determination made in 104, an indication of the change is output. Such output may be of any suitable form and may, for example, without limitation, alert an operator of the change to the forming die, provide an indication of extent of the change, cause operation of the machine and/or operation associated with the forming die to automatically cease, or be used for any other purpose without varying from the scope of the disclosed concept.

From the foregoing it is to be appreciated that the disclosed concept provides for arrangements that can detect/determine problematic and/or potentially problematic forming dies in minimal time compared to conventional solutions and typically before meaningful quantities of defective product (i.e., can bodies) is produced. Thus minimizing time and potential money wasted due to a damaged/contaminated forming die. In contrast to arrangements of the disclosed concept such as described herein, conventional solutions involve waiting for defects to start to occur on can bodies being formed, shutting down the machine (stop production) and manually inspecting the die(s) of the machine. On a necker machine, for example, the number of dies can range from 24 to 288 and take upwards of five minutes each to inspect. As a necker machine can process between 500 and 4800 can bodies per minute, the down time currently required to just identify a problematic forming die can easily set production off by hundreds of thousands of can bodies.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

What is claimed is:

1. An arrangement for use in forming a can body, the arrangement comprising:
a forming die structured to form a portion of the can body, the forming die having a portion comprising a photoluminescent material.

2. The arrangement of claim 1, further comprising:
a source of UV light positioned and structured to illuminate the portion of the forming die; and
an image capturing device positioned and structured to capture a number of images of the portion of the forming die illuminated by the source of UV light.

3. The arrangement of claim 2, further comprising a processor in communication with the image capturing device.

4. The arrangement of claim 2, wherein the source of UV light and the image capturing device comprise portions of an inspection camera.

5. The arrangement of claim 1, wherein the forming die comprises a necking die for use in performing a necking operation on a can body.

6. The arrangement of claim 1, wherein the photoluminescent material is impregnated in the forming die.

7. The arrangement of claim 1, wherein the photoluminescent material has been provided in the forming die via a doping process.

8. An apparatus for forming a portion of a can body, the apparatus comprising:
a forming die having a portion comprising a photoluminescent material;
a number of arrangements structured to move the can body into and/or out of contact with the forming die;
a source of UV light positioned and structured to illuminate the portion of the forming die; and
an image capturing device positioned and structured to capture a number of images of the portion of the forming die illuminated by the source of UV light.

9. The apparatus of claim 8, further comprising a processor in communication with the image capturing device.

10. The apparatus of claim 8, wherein the source of UV light and the image capturing device comprise portions of an inspection camera.

11. The apparatus of claim 8, wherein the photoluminescent material is impregnated in the forming die.

12. The apparatus of claim 8, wherein the photoluminescent material has been provided in the forming die via a doping process.

13. The apparatus of claim 8, wherein the number of arrangements comprises a number of transfer assemblies.

14. The apparatus of claim 8, wherein the forming die comprises a necking die for use in performing a necking operation on a can body.

15. The apparatus of claim 8, wherein the apparatus comprises a processing station of a necker machine.

16. A method of monitoring wear of a forming die structured to form a portion of a can body, the method comprising:
receiving a plurality of images of a portion of the forming die;
determining a difference in at least two images of the plurality of images corresponding to a change in the forming die; and
responsive to said determining, outputting an indication of the change.

17. The method of claim 16, wherein receiving the plurality of images of the portion of the forming die comprises obtaining the plurality of images with an image capturing device positioned adjacent the portion of the forming die.

18. The method of claim 17, further comprising illuminating the portion of the forming die with a light source while obtaining the plurality of images.

19. The method of claim 18, wherein the forming die comprises a photoluminescent material, and wherein illuminating the portion of the forming die with the light source comprises illuminating the portion of the forming die with a source of ultraviolet light.
